(19) United States
(12) Patent Application Publication
(10) Pub. No.: US 2007/0009342 A1
(43) Pub. Date: Jan. 11, 2007

(54) Plastic tolerance compensating device

(75) Inventors: Hans-Ulrich Figge, Schloss-Holte (DE); Andreas Metten, Versmold (DE); Martin Jodeleit, Bielefeld (DE)

Correspondence Address: SEYFARTH SHAW LLP, 131 S. DEARBORN ST., SUITE2400, CHICAGO, IL, 60603-5803, US

(73) Assignee: Bollhoff Verbindungstechnik GmbH

(21) Appl. No.: 11/454,346

(22) Filed: Jun. 16, 2006

(30) Foreign Application Priority Data
Jul. 11, 2005 (DE) 20 2005 010 873.1

(51) Int. Cl. F16B 43/02

(52) U.S. Cl. 411/546

(57) ABSTRACT

The tolerance compensating assembly of the present invention comprises a mounting bolt 2, a receiving part 4, and an adjustment sleeve 6. The receiving part 4 can be fixed to a first of two structural members A, B and can be screwed with the mounting bolt 2 to clamp the structural members A, B. The adjustment sleeve 6 is supported on the receiving part 4 by ramped sliding surfaces 32, 48 and has at least one driver projection 52 which co-operates with a driver projection 16 of the mounting bolt 2 such that the adjustment sleeve 6 is also driven by the mounting bolt 2 upon the mounting bolt 2 being screwed into the receiving part 4 and is moved into abutment with the second structural member B to compensate tolerance as a function of a corresponding relative movement of the ramped sliding surfaces 32, 48.

### BACKGROUND OF THE INVENTION

The present invention relates to a tolerance compensating assembly for automatically compensating tolerances in the spacing between two pre-mounted structural members or structural members to be mounted which are to be clamped together.

A great number of such tolerance compensating assemblies are known, see for example EP 0 176 663 B1, DE 42 24 575 C2, DE 101 51 383 A1, DE-GM 201 190012 and DE-GM 203 14 003. They serve in compensating the tolerance between structural members which ensues in manufacturing and/or mounting. To this end, these tolerance compensating assemblies normally comprise an adjustment sleeve having a so-called drive portion which can enter into frictional contact connection with a mounting bolt. Upon rotating the mounting bolt, the adjustment sleeve is therefore also rotated until it fixedly abuts against one of the structural members to be clamped, whereupon given further rotation of the mounting bolt and the corresponding increase in torsional force, the frictional contact connection is overcome such that both structural members can be clamped together in the adjustment sleeve by the mounting bolt.

The tolerance compensating assemblies known from the prior art normally consist either wholly or partly of metal elements, wherein the non-metallic elements are made of e.g. a thermoplastic synthetic. These known tolerance compensating assemblies are relatively expensive and those which make use of thermoplastic synthetics have the disadvantage of the clamping between the two structural members diminishing due to relaxation of the plastic.

### SUMMARY OF THE INVENTION

It is the object of the present invention to provide a tolerance compensating assembly for automatically compensating tolerances in the spacing between two structural members which are to be clamped together which can be manufactured economically and of a configuration suitable for manufacturing from plastic.

The tolerance compensating assembly configured according to the invention consists of only three components: the mounting bolt, the receiving part and the adjustment sleeve. The mounting bolt and the adjustment sleeve are in each case provided with a driver projection to matingly fit together, whereby a secure co-driving of the adjustment sleeve is attained when the mounting bolt is screwed into the receiving part.

It is preferably provided for the driver projections of the mounting bolt and the adjustment sleeve to interact elastically such that they can be moved past one another when positioning the adjustment sleeve on the second structural member so as to enable the mounting bolt to clamp the two structural members. This is achieved for example in that the driver projection is fit to the adjustment sleeve at an elastically flexible section.

The invention offers the possibility of a “complete plastic solution,” in which all three components are made of plastic. Manufacturing of the three components is thus a simple process, for example by injection molding.

### BRIEF DESCRIPTION OF THE DRAWINGS

The drawings will be used to describe an exemplary embodiment of the invention in greater detail.

FIG. 1 is a perspective view of a tolerance compensating assembly configured according to the invention prior to the mounting bolt being screwed in;

FIG. 2 is a perspective view of a sub-unit of the tolerance compensating assembly from FIG. 1 consisting of the receiving part and the adjustment sleeve;

FIG. 3 is a perspective view of the receiving part in FIGS. 1 and 2;

FIG. 4 is a perspective view of the adjustment sleeve in FIGS. 1 and 2;

FIG. 5 is a longitudinal section through the tolerance compensating assembly clamping the structural members in the mounted state;

FIG. 6 is a sectional view in the visual direction of the VI-VI arrow of FIG. 5;

FIG. 7 is an enlarged view of Detail E from FIG. 6;

FIG. 8 is a longitudinal section corresponding to FIG. 5 upon unclamping of the two structural members;

FIG. 9 is a sectional view in the visual direction of the IX-IX arrow of FIG. 8;

FIG. 10 is an enlarged view of Detail E from FIG. 9.

### DETAILED DESCRIPTION OF A PREFERRED EMBODIMENT

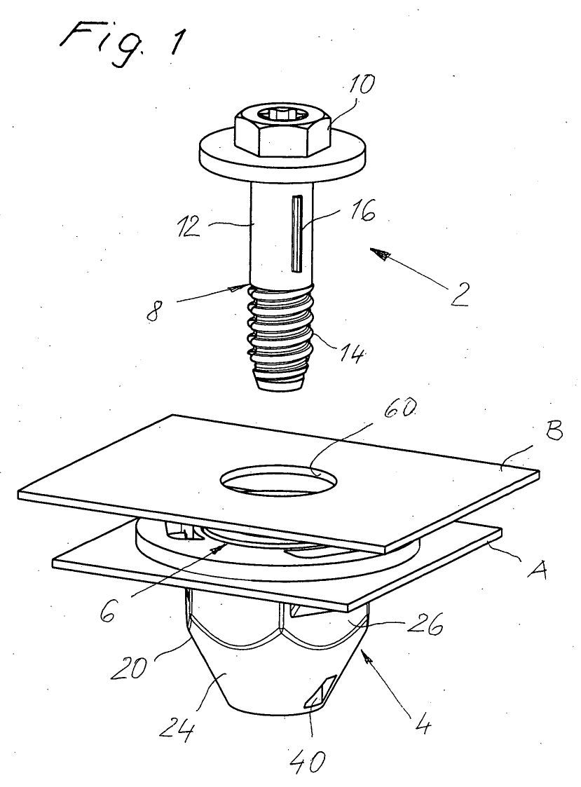

The tolerance compensating assembly shown in FIG. 1 serves to clamp the two structural members A, B and concurrently compensate the tolerance in the spacing between the said two structural members A, B. This spacing is subject to variation due to manufacturing and/or mounting tolerances in the pre-assembly or final assembly stage, which the tolerance compensating assembly can compensate.

The tolerance compensating assembly consists of a mounting bolt 2, a receiving part 4 and an adjustment sleeve 6. The receiving part 4 and the adjustment sleeve 6 can be pre-assembled into a sub-unit as shown in FIG. 2, as will be described in greater detail below.

The mounting bolt 2 consists of a shaft 8 and a head 10. The head 10 can be configured as a conventional bolt head with the corresponding drive features. The shaft 8 consists of an essentially cylindrical, smooth-surfaced shaft portion 12 and a threaded portion 14. The threaded portion 14 has a self-tapping and/or forming thread in the exemplary embodiment as shown. Two diametrically opposed driver projections 16 are disposed on the threaded portion 12 extending axially over the greater portion of the said threaded portion 12, their purpose to be described in greater detail below.

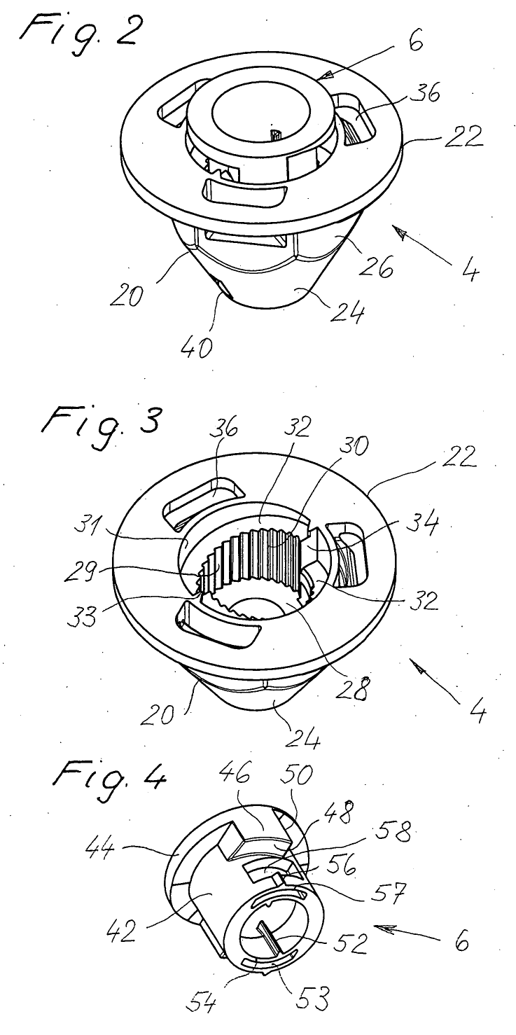

The receiving part 4 shown in FIG. 3 is configured as an annular body 20 having an annular flange 22 at its upper axial end. The annular body 20 has a conically configured insertion portion 24 and a hexagonal periphery 26, also see FIG. 2.

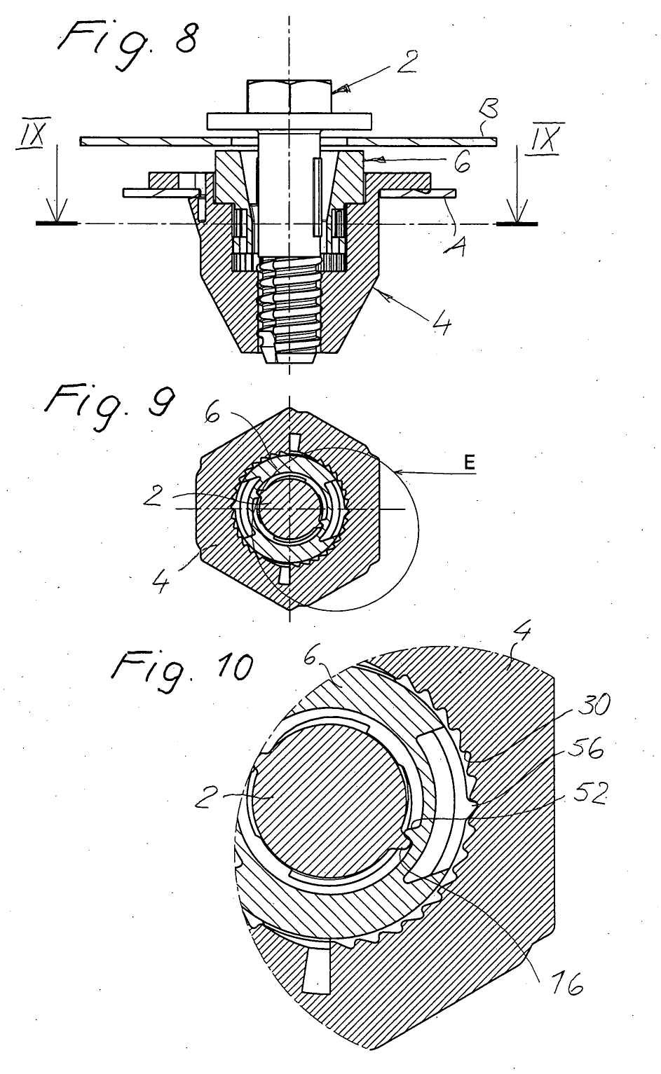

The annular body 20 with the annular flange 22 has a throughbore which is configured in the lower section as a smooth-surfaced bore portion 28 and which serves to receive the threaded portion 14 of the mounting bolt 2, see also FIGS. 5 and 8. A further bore portion 29 joined to bore portion 28 is provided at its inward facing side with two diametrically opposed gearings 30 distributed over the periphery. A further bore portion 31 of larger diameter is joined to bore portion 29. The shoulder between the said two bore portions 29 and 31 is configured from two peripherally-extending diametrically-opposed ramped sliding surfaces 32. An axially-extending limit stop surface 34 is configured in each case between the two ramped sliding surfaces 32. A stopper 33, formed as a projection protruding radially inwardly, is provided at the position of each limit stopper 34.

Flange 22 is provided with three openings 36 spaced along its periphery. A clip 38 is disposed in proximity to the said openings 36 (FIGS. 5 and 8) to fix the receiving part 4 to structural member A. Lastly, the conical insertion portion 24 has two diametrically opposed recesses 40, see in particular FIG. 1.

The adjustment sleeve 6 shown in FIG. 4 consists of a generally cylindrical sleeve body 42 with an annular flange 44 fit to one axial end. Two diametrically opposed, axially downward extending nubs 46 are provided on the underside of the annular flange 44, each provided with a ramped sliding surface 48 at their undersides. On one side of each of nubs 46 is an axially extending limit stop surface 50 running transverse to the associated ramped sliding surface 48.

The sleeve body 42 has two diametrically opposed driver projections 52 at its inside which extend axially and protrude radially inwardly. The said driver projections 52 are each fit to an elastically flexible section 54, its give a function of the axially extending slots 53.

The adjustment sleeve 6 is further provided at its exterior with two diametrically opposed retention projections 56 which are likewise fit to an elastically flexible section 57 at an axial end of adjustment sleeve 6. The give of the elastic section 57 is on one hand a function of the associated slot 53 and on the other the axially adjacent opening 58.

The mounting bolt 2, the receiving part 4 and the adjustment sleeve 6 are each made of plastic. The receiving part 4 and the adjustment sleeve 6 are preferably made of a fiber-reinforced thermoplastic such as, for example, an impact-modified PA. The mounting bolt 2 can likewise be made of a fiber-reinforced thermoplastic, which however has a higher strength than the plastic of the receiving part 4 and the adjustment sleeve 6. For example, the mounting bolt 2 can be made of a high fiber-filled PPS.

The assembly and operation of the tolerance compensating assembly will now be described:

The receiving part 4 (FIG. 3) and the adjustment sleeve 6 (FIG. 4) are first pre-assembled into the sub-unit shown in FIG. 2. For this purpose, the adjustment sleeve 6 is inserted into the throughbore of the receiving part 4 from above with its small diameter first. When the ramped sliding surfaces 32 and 48 abut against one another, the receiving part 4 and the adjustment sleeve 6 are then brought into an initial position by a relative rotation in which the limit stop surface 34 of the receiving part 4 and the limit stop surface 50 of the adjustment sleeve 6 abut against one another. This initial position is secured by the retention projections 56 of the adjustment sleeve 6 abutting the rear section of the recesses 40 (FIG. 1) of the receiving part 4. In this initial position, the sub-unit comprised of the receiving part 4 and the adjustment sleeve 6 has its smallest possible axial dimension.

The sub-unit 4, 6 is now fixed to the pre-assembled structural member A by inserting it from above into a hexagonal hole of the said structural member A. When the flange 22 of the receiving part 4 abuts against the top of the structural member A, the spring-mounted clips 38 abut against the lower side of the said structural member A such that the receiving portion is fixed in the axial direction. At the same time, the receiving portion A with its hexagonal periphery 26 is fixed in the hexagonal hole of the said structural member A in the circumferential direction. The torque ensuing from operating the tolerance compensating assembly can be reliably taken up here without unfavorably impacting the position of the tolerance compensating assembly. The receiving part 4 can, however, also be fixed to structural member A in a constructionally different manner.

If the structural member B is now likewise mounted at a certain spacing from structural member A, the structural members A and B are clamped to one another by means of the mounting bolt 2, wherein a compensation of the tolerances in the spacing between the structural members A and B is compensated at the same time.

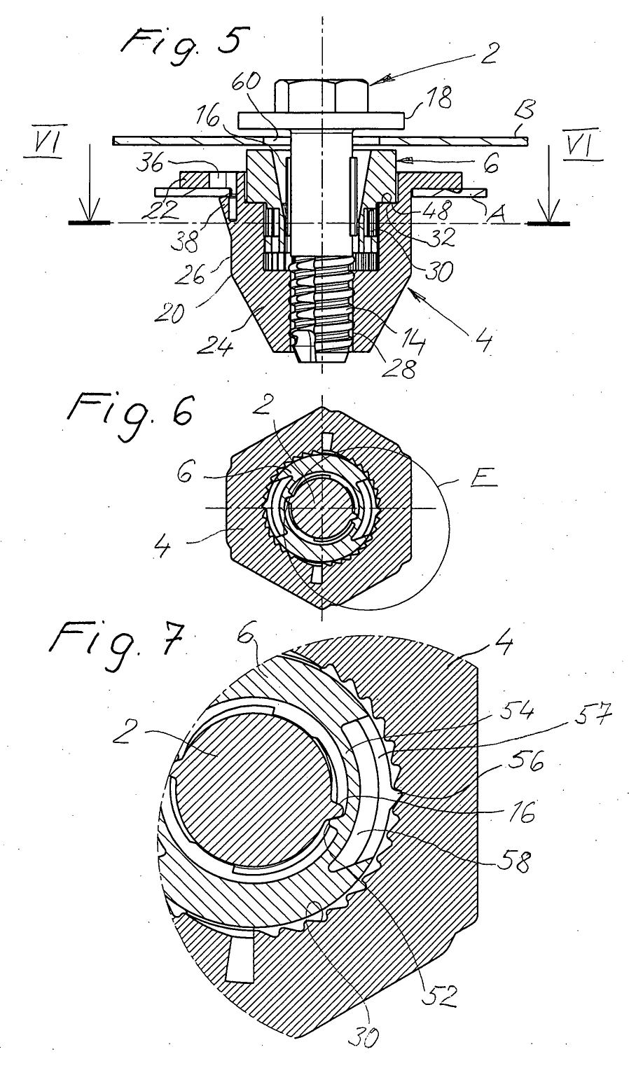

For this purpose, the mounting bolt 2 is screwed into a hole 60 of the structural member B—clockwise in FIG. 7—in the bore portion 28 of the receiving part 4 (FIGS. 5-7). As mentioned above, the thread of the mounting bolt 2 is configured as a self-tapping and/or forming thread, which forms a corresponding counter-thread in the smooth surface-configured bore portion 28. Since these types of plastic-in-plastic threaded connections are known in the art, no further description of them will be given here. It is, however, pointed out that the bore portion 28 can also be provided with a pre-formed receiving thread.

When the mounting bolt 2 is screwed into the receiving part 4 by a given amount, the driver projections 16 of the mounting bolt 2 enter into the engaging area of the driver projections 52 of the adjustment sleeve 6. If the mounting bolt 2 is now rotated further, it then drives the adjustment sleeve 6 along with it. The ramped sliding surfaces 48 of the adjustment sleeve 6, which have a smaller peripheral extension than the ramped sliding surfaces 32 of the receiving part 4, hereby slide along the ramped sliding surfaces 32. The ramped sliding surfaces 32 and 48 are oppositely inclined to the thread pitch of the threaded portion 14 of the mounting bolt 2. The adjustment sleeve 6 thus unscrews axially upward from the receiving part 4 until it abuts the underside of the structural member B. The spacing between the structural members A and B is now bridged.

During this rotational motion, the retention projections 56 of the adjustment sleeve 6 move along the teeth of the gearing 30 of receiving part 4 (FIG. 7). This is enabled by the fact that the retention projection 56 is fit to the elastically flexible section 57 and is thus to a certain extent spring-mounted. The adjustment sleeve 6 is hereby secured in each position reached. In all other respects, the adjustment sleeve 6 is limited in its maximum rotational motion (½ revolution) by the two stoppers 33 of the receiving part 4 so as to avoid the adjustment sleeve 6 inadvertently slipping into the initial position.

If the mounting bolt 2 is now screwed in further, in order to clamp the two structural members A, B to one another, the driver projections 16 of the mounting bolt 2 “pass over” the driver projections 52 of the adjustment sleeve 6. This is enabled by the fact that the driver projections 52 are elastically flexible due to the elastic section 32.

The mounting bolt 2 can now be rotated further until the flange 18 abuts against the mounting bolt 2 at the top of the structural member B. Clamping the two structural members A, B does not require a high starting torque for mounting bolt 2 since the plastic-in-plastic threaded connection between the mounting bolt 2 and the bore portion 28 of the receiving part 4 ensures a sealed threading. Yet as previously mentioned, a different threaded connection giving a sealed threading in the form of, for example, a thread pitch offsetting, a locknut or the like can also be provided.

If the clamping of the two structural members A, B is then to be unclamped again (FIGS. 8-10), the mounting bolt 2 is unscrewed from the receiving part 4 in the opposite direction (counterclockwise in FIG. 10). In the exemplary embodiment as shown, the adjustment sleeve 6 is thereby held in its position, since the retention projections 56 can only be moved in one direction (clockwise in FIG. 10) past the teeth of the gearing 30. If, in contrast, the adjustment sleeve 6 is to be rotated back into its initial position by the mounting bolt 2, the retention projections 56 and the gearing 30 can also be configured such that the retention projections 56 can move past the teeth of the gearing 30 in both directions of rotation.

We claim:

1. A tolerance compensating assembly for automatically compensating tolerances in the spacing between two structural members which are to be clamped together, comprising:
a mounting bolt having at least one driver projection,
a receiving part which can be fixed to a first of the two structural members and which can be screwed with the said mounting bolt to clamp the structural members, and
an adjustment sleeve which is supported on the receiving part by ramped sliding surfaces and which has at least one driver projection which interacts with the driver projection of the mounting bolt such that the adjustment sleeve is also driven by the mounting bolt upon the said mounting bolt being screwed into the receiving part and is moved into abutment with the second structural member to compensate tolerance as a function of a corresponding relative movement of the said ramped sliding surfaces.

2. A tolerance compensating assembly according to claim 1, characterized in that the driver projections of the adjustment sleeve and the mounting bolt interact elastically such that they can be moved past one another when positioning the adjustment sleeve on the second structural member so as to enable the mounting bolt to clamp the two structural members.

3. A tolerance compensating assembly according to claim 2, characterized in that the driver projection of the adjustment sleeve is fitted to an elastically flexible section.

4. A tolerance compensating assembly according to claim 1, characterized in that the adjustment sleeve is configured generally cylindrical and has a flange at one axial end, at the underside of which nubs are provided for the ramped sliding surfaces of the said adjustment sleeve.

5. A tolerance compensating assembly according to claim 4, characterized in that the nubs of the adjustment sleeve have limit stop surfaces running transverse to the ramped sliding surfaces to which abut the corresponding limit stop surfaces of the receiving part in an initial position of the tolerance compensating assembly.

6. A tolerance compensating assembly according to claim 5, characterized in that the initial position of the tolerance compensating assembly is secured by a locking between the receiving part and the adjustment sleeve.

7. A tolerance compensating assembly according to claim 1, characterized in that a locking gearing is provided between the receiving part and the adjustment sleeve in the form of at least one flexible retention projection and a gearing in order to secure the said adjustment sleeve in its position relative to the receiving part.

8. A tolerance compensating assembly according to claim 1, characterized in that the receiving part has stoppers to limit the motion of the said adjustment sleeve relative to the receiving part.

9. A tolerance compensating assembly according to claim 1, characterized in that the receiving part is configured as an annular body having a mounting flange on one axial end and a receiving bore at an axially opposite area for the mounting bolt.

10. A tolerance compensating assembly according to claim 9, characterized in that the mounting bolt has a self-tapping and/or forming thread which can be screwed into the smoothly-configured receiving bore of the receiving part.

11. A tolerance compensating assembly according to claim 10, characterized in that the screw connection between the mounting bolt and the receiving bore of the receiving part is a plastic-in-plastic threaded connection.

12. A tolerance compensating assembly according to claim 1, characterized in that the receiving part has fitted clips to axially fix to a first structural member.

13. A tolerance compensating assembly according to claim 1, characterized in that the receiving part has a polygonal periphery to axially fix to a first structural member in the circumferential direction.

14. A tolerance compensating assembly according to claim 1, characterized in that the mounting bolt, the receiving part and the adjustment sleeve are all made of plastic.

15. A tolerance compensating assembly according to claim 14, characterized in that the receiving part and the adjustment sleeve are made of an impact-modified fiber-reinforced thermoplastic, preferably polyamide.

16. A tolerance compensating assembly according to claim 14, characterized in that the mounting bolt consists of a high fiber-filled PPS.
